(19) United States
(12) Patent Application Publication
(10) Pub. No.: US 2003/0179398 A1
(43) Pub. Date: Sep. 25, 2003

(54) Image forming method and image forming apparatus

(76) Inventors: Hiroaki Takano, Tokyo (JP); Tsukasa Ito, Tokyo (JP)

Correspondence Address: CANTOR COLBURN LLP, 55 Griffin Road South, Bloomfield, CT, 06002, US

(21) Appl. No.: 10/388,879

(22) Filed: Mar. 14, 2003

(30) Foreign Application Priority Data
Mar. 20, 2002 (JP) JP2002-078209

(51) Int. Cl. H04N 1/58; H04N 1/60; G06T 5/00; G06K 15/02

(52) U.S. Cl. 358/1.9; 358/3.26; 358/3.27; 358/516; 358/518; 358/527; 358/532; 358/506

(57) ABSTRACT

An image forming method, comprises steps of scanning a pigment image on a film and producing digital image data corresponding to the pigment image; providing the digital image data with additional data representing at least one of a judgment result obtained by judging a photographing condition of the pigment image, and image processing condition for the digital image data determined on a basis of the judgment result for the photographing condition, a scanning condition at the scanning step; and a pigment image forming condition of the pigment image on the film; processing the digital image data on a basis of the additional data; and forming an image on a basis of the processed digital image data.

### BACKGROUND OF THE INVENTION

The present invention relates to an image input apparatus and image output apparatus by which the image information is read from the document and which is used, for example, when, based on the image information, each kind of image processing is conducted or prints are made, and to an image recording apparatus structured by them.

A photographic system using a silver halide color photographic photosensitive material is more and more developed recently, and by the spread of a color lab which is a large scale centralized center at which a large amount of color prints are produced in high efficiency, or a so-called mini lab which is a small sized and simple printer processor installed in a shop, every people can easily enjoy the color photography.

In the principle of the color photography which is spread presently, the color reproduction by the subtractive color process is adopted. In the general color negative film, on the transmission supporting body, the photosensitive layer using the silver halide emulsion which is a photosensitive element to which the photosensitivity is added in the blue, green, and red area, is provided, and in those photosensitive layers, so-called color couplers forming the color element of yellow, magenta, and cyan which are hues respective of which are the complementary colors, are combined and included.

The color negative film on which the image-wise exposure is conducted by the photographing, is developed in the color developing liquid including the aromatic first class amine developing agent. At the time, the silver halide particle which is exposed, is developed, that is, reduced by the developing agent, and each coloring mater is formed by the coupling reaction of the oxidant simultaneously generated of the developing agent and the color coupler. After that, the coloring matter image is obtained when the metallic silver generated by the development and un-reacted silver halide are respectively removed by bleaching and fixing processing.

The optical exposure is given to the color print paper which is a color photosensitive material, in which the photosensitive layer having the combination of the same photosensitive wavelength area and coloring hue is coated on the reflection supporting body, through the color negative film after the development processing, and when the same color development and bleaching and fixing processing are conducted, the color print formed of the coloring matter image by which the original scene is reproduced is obtained.

In the conventional analog method by which the optical exposure is given to the color print paper through the color negative film after the development processing, when the exposing time onto the print paper, and the color balance of the exposing light-are adjusted, the color print having the adequate density and color reproduction, is obtained. Although the exposure time or adjustment of the color balance are automated by the high degree control technology, in the photographic scene such as a rear-light or strobe proximity photographing, the manual operation by the operator is necessary. This is for the reason that, depending on the existence of the object having the high reflectance or luminance ratio, the deviation is generated in the color negative film coloring density in the photographing frame, and the average density in the photographing frame does not express the lightness of the photographing scene centering around the main object. In this case, the operator specifies the portion which is seemed to be main object in the photographing frame, and the adjusting operation is repeated until the appropriate density of the color pint is obtained. This shows that, on the other hand that the color negative film has the excellent light acceptability (called also “dynamic range”) by which the object information having the high reflection ratio or luminance ratio can be recorded, it is very difficult that the specific density area of the recorded coloring matter image information is automatically adjusted so that the desired density is obtained on the print paper.

Recently, a method is known by which an image formed on a color negative film is optically read by using the scanner, and after it is changed to the image signal, the image processing is conducted and the digital image data is made once. On such an image signal, after various image processing represented by the negative positive reversal, gradation adjustment, luminance adjustment, color balance adjustment, granularity adjustment, and sharpness emphasis, are conducted, it is distributed by the medium such as a CD-R, floppy (R) disk, or memory card, or via the internet, and outputted by the silver halide print paper, inkjet printer, or thermal printer, as the hard copy image, or displayed on a medium such as a CRT, liquid crystal display, or plasma display, and admired.

A system used in a photo-service by which a color negative film is read by using the scanner, and a positive digital image is formed, and the color print is made by using this, or saved in a recording medium and provided, will be detailed below.

After the transmitted light information from the light source irradiated on the color negative film is received by an image sensor, the signal processing from analog to digital by an A/D converter is conducted. The sampling number in this case is expressed by a bit width, and the larger the bit width (for example, 16 bits=65536 gradations) is, the more the sampling interval is dense, and the sufficient information amount and the accuracy required for the processing for forming a positive image are given. This is specially important in the meaning that, in a partial gradation elongation or precipitous processing, the digitizing of the gradation is prevented, and the generation of the noise is lowered. The obtained digital signal is converted from the transmission scale to the density scale, and after various processing such as the negative positive reversal and gradation adjustment, are conducted, by using the digital exposure unit whose light source is the LED light source or semiconductor laser, it is recorded on the print paper. On the one hand, for the recording medium in which the digital image data is stored and presented to the customer, the digital image data whose pixel number or bit width is reduced, (for example, about 1,500 thousands pixels, 8 bits=256 gradations), is used.

The digital image data is, in the same manner as the color print formed in the same manner as the conventional analog method, via adjustment process to adjust the specific density area to the desired gradation reproduction on the output device such as a CRT, from the coloring matter image information of the broad density area recorded in the color negative film. Accordingly, by using the retouch function of the application software (for example, “Photo shop” by Adobe Co.) when the customer itself corrects it so that the gradation of the digital image data is formed as a desired color image, because all the object information recorded in the color negative film are not possessed already, it becomes a cause of the phenomena such as white spot (in the case of 8 bits,=255), or lacking (in the case of 8 bits,=0).

In Japanese Tokkaihei No. 10-13680, a method is disclosed by which the image status is judged from the image information, and corresponding to the image information and judged image status, the intermediate density portion of the image is not changed, and the processing condition for respectively independently non-linearly compressing or extending the low density portion and/or high density portion of the image is set, and the image processing corresponding to this processing condition is conducted and by generating the output image information, the adequate image information processing such as the over/under exposure, rear-light or strobe photographing, is conducted, and the adequately finished print is stably obtained.

In Japanese Tokkaihei No. 11-53535, a method is disclosed by which the density histogram is made from the original image and the density range is calculated, next the dynamic range compression extending ratio a is calculated, and after the blurred image 1 generated by the median filter (MF) from the original image and the blurred image 2 generated by the low pass filter (LPF) are weighed and added, by using the previously obtained compression extending ratio α, it is compressed and extended and the blurred image is generated, and by subtracting the lastly obtained blurred image from the original image, even when it is an image with the high contrast and broad dynamic range such as the rear-light or strobe photographing image, or even when it is an image with the low contrast and narrow dynamic range such as the photographing image at the time of cloudy day, the adequate high image quality reproduction image is stably obtained.

In Japanese Tokkai No. 2001-245153, an image processing method is disclosed by which the dodging processing by which “undesired space” or “undesired doubling” of the bright portion in the flash light photographing or rear-light scene can be eliminated by selecting the 1 or more basic compression (extending) characteristics from the previously set plurality of basic compression (extending) characteristics, can be conducted in a shorter processing time.

These methods are relating to a method for processing a preferable color print stably and in a short time, and are not the technology relating to the color negative film substitution by which the information to increase the retouch property by the user itself is newly given, to the digital image data presented to the user, or even when the already developed color negative film does not exist, the same information can be obtained.

Further, in Japanese Tokkai No. 2000-152279, and U.S. Pat. No. 6,301,393, a method is disclosed by which, in the specific image input output system having the device dependent type color space, the color difference from the device independent type color space, (for example, CIE L*a*b, XYZ) which is not dependent on the device, is extracted, and stored as the difference file. This relates to the interchangeability of the device using the device dependent type color specification system with the other display apparatus, and is not a method by which the color negative film information more than the conventional method is extracted and can be provided.

In Japanese Tokkaihei No. 10-79854, No. 10-191055, No. 11-266358, and Tokkai No. 2000-196890, various methods are disclosed by which the specified object position is adjusted to an adequate lightness. These are methods by which the accuracy for generating the digital image data used for the color print production more stably is increased, and are not methods by which more color negative film information is extracted, and can be provided.

The Flash Pix Format in which the digital image data for each resolution is stored in one file, is well known. Because the application can make access to the necessary resolution digital data, it is not necessary to make access to the maximum resolution digital data as the conventional one, and to envelop all in the memory, and the reduction of the operation process to change the resolution corresponding to the purpose or output device, is attained.

As described above, the digital image data stored in a recording medium such as “CD-R”, or “MO” is optimized under the presupposition of the enjoy mainly on a CRT monitor, or an output by the household printer, and it is general that the quality of the digital image data is different from the result of the image processing conducted at the time of the print production. That is, it is rare that the print production is ordered again from only the digital image data, and the same quality print is obtained. Further, when only the negative film exists, by further improved image processing method other than the above disclosed technology, the chance at which the high quality print is obtained later, is obtained, however, from the digital image data stored in the recording medium such as “CD-R” or “MO”, not only the rich information which the negative film has, can be obtained, but also it is the actual situation that it is not clear that it is the digital image data read from the negative film. Further, when the digital image data stored in the recording medium is used for the print production, although the effect of the reduction of a constant operating time necessary for the scanning is obtained, the troublesomeness of the operation is not changed, and it is difficult to say that the necessary processing time and labor are also sufficiently small.

### SUMMARY OF THE INVENTION

Referring to the above-described actual situation, the present invention is attained, and the object of the present invention is to increase the quality of the re-print from the digital image data obtained by scanning the negative film, and to improve the print production efficiency.

An image input apparatus of the first present invention in which, after the pigment image information recorded in a film is read by scanning by an image input medium and converted into an electric signal, the digital image data is generated by conducting a predetermined image processing, the image input apparatus is characterized in that: a means for adding the information showing that the digital image data is generated by scanning of the film to the digital image data, is provided.

An image input apparatus of the second present invention in which, after the pigment image information recorded in a film is read by scanning by an image input medium and converted into an electric signal, the digital image data is generated by conducting a predetermined image processing, the image input apparatus is characterized in that: a means for adding the information relating to the film to the digital image data is provided. Herein, as the information relating to the film, representatively, it is selected from the kind of negative and positive, film size, ISO sensitivity, and film product name.

An image input apparatus of the third present invention in which, after the pigment image information recorded in a film is read by scanning by an image input medium and converted into an electric signal, the digital image data is generated by conducting a predetermined image processing, the image input apparatus is characterized in that: a means for adding the information used for the judgment when the digital image data is generated to the digital image data, is provided. Herein, the information used for the judgment when the digital image data is generated is selected from the exposure condition (under, normal, or over), rear-light (reverse light), gray balance condition, and mask density.

An image input apparatus of the third present invention in which, after the pigment image information recorded in a film is read by scanning by an image input medium and converted into an electric signal, the digital image data is generated by conducting a predetermined image processing, the image input apparatus is characterized in that: a means for adding the information relating to the image processing set when the digital image data is generated to the digital image data is provided. Herein, the information relating to the image processing set is selected from representatively the γ set, color balance set, saturation adjustment, sharpness adjustment, granularity suppression, and dust and flaw removal.

An image input apparatus of the fifth present invention in which, after the pigment image information recorded in a film is read by scanning by an image input medium and converted into an electric signal, the digital image data is generated by conducting a predetermined image processing, the image input apparatus is characterized in that: a means for adding the information showing either of automatic or manual one is the condition set for generating the digital data, to the digital image data, is provided.

An image input apparatus of the sixth present invention in which, after the pigment image information recorded in a film is read by scanning by an image input medium and converted into an electric signal, the digital image data is generated by conducting a predetermined image processing, the image input apparatus is characterized in that: a means for adding the information showing that the film is scanned just after the development, or that the developed film brought in by the customer is scanned, to the digital image data is provided.

An image output apparatus of the seventh present invention in which a means by which a predetermined image processing is conducted on the inputted digital image data and the digital image data for output is generated, and a means for outputting the digital image data for output, are provided, the image output apparatus is characterized in that: a means for generating the digital image data for output is provided with a means for judging whether the digital image data is the digital image data generated by scanning the film, and according to the judged result, provided with a means for changing the content and set of the image processing relating to the image output. Herein, the content and set of the image processing is selected from representatively the gradation conversion, sharpness emphasis, granularity suppression, color balance set, saturation adjustment, and dust and flaw removal.

An image output apparatus of the eighth present invention in which a means by which a predetermined image processing is conducted on the inputted digital image data and the digital image data for output is generated, and a means for outputting the digital image data for output, are provided, the image output apparatus is characterized in that: a means for generating the digital image data for output is provided with a means for judging whether the digital image data is the digital image data generated by scanning the film, and a means for obtaining the information relating to the film, and according to at least one of the information from these two means, a means for changing the content and set of the image processing relating to the image output is provided. Herein, the information relating to the film, is selected from representatively the kind of the negative and positive film, film size, ISO sensitivity, and film product name, and the content and set of the image processing relating to the image output is selected from representatively the gradation conversion, sharpness emphasis, granularity suppression, color balance set, and saturation adjustment.

Further, in the image output apparatus of the eighth present invention, it is preferable to satisfy at least one of the items such as (1) in the content for changing the content and set of the image processing relating to the image output according to at least one of the information from the two means, the granularity suppression degree of the granularity suppressing set of the negative film resulting image is higher than that of the granularity suppressing set of the positive film resulting image, (2) in the content for changing the content and set of the image processing relating to the image output according to at least one of the information from the two means, the non-linearity degree of the gradation correction set of the negative film resulting image is higher than that of the gradation correction set of the positive film resulting image, (3) in the content for changing the content and set of the image processing relating to the image output according to at least one of the information from the two means, the granularity suppression degree of the granularity suppression set of the film resulting image whose film size is small is higher than that of the granularity suppression set of the film resulting image whose film size is large, (4) in the content for changing the content and set of the image processing relating to the image output according to at least one of the information from the two means, the granularity suppression degree of the granularity suppression set of the film resulting image whose ISO sensitivity is high is higher than that of the granularity suppression set of the film resulting image whose ISO sensitivity is low, (5) in the content for changing the content and set of the image processing relating to the image output according to at least one of the information from the two means, the emphasis degree of the saturation emphasis set of the film resulting image whose ISO sensitivity is high is higher than that of the saturation emphasis set of the film resulting image whose ISO sensitivity is low, or (6) the content for changing the content and set of the image processing relating to the image output according to at least one of the information from the two means changes at least one selected from the gradation conversion, sharpness emphasis, granularity suppression, color balance set, and saturation adjustment, according to the film product name.

An image output apparatus of the ninth present invention in which a means by which a predetermined image processing is conducted on the inputted digital image data and the digital image data for output is generated, and a means for outputting the digital image data for output, are provided, the image output apparatus is characterized in that: the means for generating the digital image data for output is provided with: a means for judging whether the digital image data is an image generated by scanning from the film; and a means for obtaining the information used for the judgment when the digital image data is generated; and a means for changing the content and set of the image processing relating to the image output according to at least one of the information from the two means.

In the image output apparatus of the ninth present invention, it is preferable to satisfy at least one of items such as (1) the information used for the judgment when the digital image data is generated is at least one selected from the exposure condition (under, normal, over), rear-light, gray balance condition, and mask density processing method, (2) the content and set of the image processing relating to the image output is at least one selected from the gradation conversion, sharpness emphasis, granularity suppression color balance set, saturation adjustment, and white balance adjustment, (3) the content for changing the content and set of the image processing relating to the image output according to at least one of the information from the two means changes the nonlinear degree of the gradation correction according to the exposure condition (under, normal, over), (4) the content for changing the content and set of the image processing relating to the image output according to at least one of the information from the two means increases the nonlinear degree of the gradation correction in the case of the rear-light, (5) the content for changing the content and set of the image processing relating to the image output according to at least one of the information from the two means, when the value of the color balance situation is not within a predetermined range, suppresses the saturation emphasis, and (6) the content for changing the content and set of the image processing relating to the image output according to at least one of the information from the two means increases the degree of the white balance adjustment when the mask density processing method is according to the presumed value, comparing to the case where the mask density processing method is according to the actual measurement.

An image output apparatus of the tenth present invention in which a means by which a predetermined image processing is conducted on the inputted digital image data and the digital image data for output is generated, and a means for outputting the digital image data for output, are provided, the image output apparatus is characterized in that: the means for generating the digital image data for output is provided with; a means for judging whether the digital image data is the data generated by scanning the film; and a means for obtaining the information relating to the image processing set when the digital image data is generated; and a means for changing the content and set of the image processing relating to the image output according to at least one of the information from the two means.

In the image output apparatus of the tenth present invention, it is preferable to satisfy at least one of the items such as (1) the content and set of the image processing relating to the image output, is at least one selected from γ setting, color balance set, saturation adjustment, sharpness adjustment, granularity suppression, and dust and flaw removal, (2) the content changing the content and set of the image processing relating to the image output according to at least one of the information from the two means changes, referring to the information of γ setting when the digital image is generated, the γ setting of the image processing relating to the image output, (3) the content changing the content and set of the image processing relating to the image output according to at least one of the information from the two means changes, referring to the color balance set when the digital image is generated, the color balance set of the image processing relating to the image output, (4) the content changing the content and set of the image processing relating to the image output according to at least one of the information from the two means changes, referring to the information of the saturation adjustment set when the digital information is generated, the saturation adjustment set of the image processing relating to the image output, (5) the content changing the content and set of the image processing relating to the image output according to at least one of the information from the two means changes, referring to the information of the sharpness degree adjustment set when the digital information is generated, the sharpness degree adjustment set of the image processing relating to the image output, (6) the content changing the content and set of the image processing relating to the image output according to at least one of the information from the two means changes, referring to the information of the granularity suppression set when the digital information is generated, the granularity suppression set of the image processing relating to the image output, (7) the content changing the content and set of the image processing relating to the image output according to at least one of the information from the two means changes, referring to the information of the dust and flaw removal set when the digital information is generated, the dust and flaw removal set of the image processing relating to the image output.

An image output apparatus of the 11th present invention in which a means by which a predetermined image processing is conducted on the inputted digital image data and the digital image data for output is generated, and a means for outputting the digital image data for output, are provided, the image output apparatus is characterized in that: the means for generating the digital image data for output has, a means for judging whether the digital image data is generated by scanning the film, and a means for obtaining the information showing either of automatic or manual one is the condition set for generating the digital image data, and has a means for changing the content and set of the image processing relating to the image output according to at least one of the information from the two means. Herein, the content for changing the content and set of the image processing relating to the image output according to at least one of the information from the two means is, when the condition setting for generating the digital image data is conducted by manual one, preferable to suppress at least one selected from the γ set in the image processing relating to the image output, color balance set, saturation adjustment, sharpness adjustment, and granularity suppression.

An image output apparatus of the 12th present invention in which a means by which a predetermined image processing is conducted on the inputted digital image data and the digital image data for output is generated, and a means for outputting the digital image data for output, are provided, the image output apparatus is characterized in that: the means for generating the digital image data for output has, a means for judging whether the digital image data is generated by scanning the film, and a means for obtaining the information showing whether the film is scanned just after the development, or the developed film brought in by the customer is scanned, and a means for changing the content and set of the image processing relating to the image output according to at least one of the information from the two means. Herein, when the content changing the content and set of the image processing relating to the image output according to at least one of the information from the two means is one which the developed film brought in by the customer is scanned, it is preferable to intensify the dust and flaw removal of the image processing relating to the image output. Further, when the content changing the content and set of the image processing relating to the image output according to the information is one which the developed film brought in by the customer is scanned, it is preferable to suppress at least one selected from the γ setting in the image processing relating to the image output, color balance set, and saturation adjustment.

In the image output apparatus of the seventh—12th present invention, the means for outputting the digital image data for output can output to the apparatus for outputting to the recording medium as the analog image. As an apparatus outputting to the recording medium as an analog image, according to the digital image data of the silver halide system (according to the digital image data for output, on the output medium such as a print paper, by the optical exposure using the CRT, LED, or laser, a system in which 2 dimensional visible image is formed), inkjet system, electro-photographing system, sublimation system, and heat sensitive system, are representative. Further, in the image output apparatus of the seventh—12th present invention, a means for outputting the digital image for output, may also be a means for outputting to the apparatus for outputting to the recording medium as the digital image data. As the recording medium in this case, it is preferable that it is at least one selected from CD-R, CD-RW, MD, memory card, IC card, floppy (R) disk, and magnetic disk. The output may be directly outputted to the apparatus through a cable, or transmitted to the apparatus through a communication line.

An image recording apparatus of the 13th present invention is structured by combining one of the image input apparatus of the first—sixth present invention with one of the image output apparatus of the seventh—12th present invention.

### BRIEF DESCRIPTION OF THE DRAWINGS

FIG. 1 is a block diagram for explaining a function of the film scan data processing section in the image processing section according to the present invention.

FIG. 2 is a block diagram for explaining a function of the image adjustment processing section in the image processing section according to the present invention.

FIG. 3 is a flow chart for explaining a movement of the print processing which is an embodiment of an image recording apparatus of the present invention.

FIG. 4 is a flow chart for explaining a movement of the header information analysis processing according to the present invention.

FIG. 5 is a flow chart for explaining a movement of the film information referring according to the present invention.

FIG. 6 is a flow chart for explaining a movement of the scanner judgment referring according to the present invention.

FIG. 7 is a flow chart for explaining a movement of the image processing set information referring according to the present invention.

FIG. 8 is a view showing the adjustment of the sharpness, and granularity processing amount.

FIG. 9 is a view showing the adjustment of the sharpness, granularity, and saturation processing amount.

FIG. 10 is a view for explaining an example of the gradation conversion method.

FIG. 11 is a view showing an embodiment of the image input apparatus of the present invention.

FIG. 12 is a view showing an embodiment of the image input using the image input apparatus of the present invention.

FIG. 13 is a conceptual view showing an image recording apparatus of the present invention.

FIG. 14 is a block diagram showing the structure of the embodiment of an image recording apparatus of the present invention.

FIG. 15 is a black diagram showing the structure of the embodiment of the image processing section according to the present invention.

### DETAILED DESCRIPTION OF THE PREFERRED EMBODIMENT

Hereinafter, so long as specially not mentioned, an image input apparatus of the first—sixth present invention, an image output apparatus of the seventh—12th present invention, and an image recording apparatus of the 13th present invention are collected and called the present invention. The present invention will be detailed below.

In the present invention, a “film” is, other than the Centurya series by Konica Co., which is a conventional color negative film (hereinafter, called also “color negative film”), the photographic photosensitive material (hereinafter, called also “photosensitive material”) in which the silver halide is used and which is represented by the reversal film and monochromatic film. Further, like as the conventional color negative film, it may also be an exclusive use color negative film designed so that it is conformable by the film scanner reading, in which the print operation by the projection exposure onto the print paper by using the analog printer is not made a presupposition. As the exclusive use color negative film, for example, as disclosed in Japanese Tokkai No. 2000-310840, for extracting the luminance information and chromatic information of the digital image data, a film which has the photosensitive layer for recording the luminance information, preferably, which, further, independently has the photosensitive layer for recording the chromatic information, or as written in Japanese Tokugan No. 2001-33492 specification, a mode which has the spectral sensitivity characteristic imitating the human eyes visual sense characteristic, or sensitivity balance, are listed.

In the present invention, “the pigment image information recorded in the film” is each pigment amount (“pigment image information”) of yellow, magenta, and cyan, which respectively corresponds to 3 primary color components of red, green and blue which is, for example, the object color (image) information recorded in the color negative film, and generated by the development processing, and the optical density information (for example, infrared image information) except each pigment amount. Herein, the “development processing” may also be any development processing of the liquid development processing called “C-41 processing”, or the thermal developing processing by which the processing sheet including the developing agent, after the film is swelled by the water, is pasted up each other, and pressure contacted by the heat block or drum and heat processed.

Further, in the present invention, the exposed color negative film can be processed by using the processing tank, publicly known in the technical field as the low capacity thin type tank processing system (LVTT) having the lack and tank or automatic tray design. Specifically, as a preferable example of such a processing method and apparatus, these are written in detail in Japanese Tokkaihei No. 8-44006.

Further, in the present invention, the exposed color negative film may also be conducted by the un-desilverizing processing. The un-desilverizing processing means a processing method by which the bleaching and fixing processing in the development processing process of the image-wise exposed color negative film is completed in a non-perfect condition, or not perfectly conducted condition, that is, when developed by using the aromatic first class amine development agent, the exposed silver halide particles complete the development processing process under the condition that the metallic silver (developing silver) generated by developed by the developing agent and un-reacted silver halide are remained. In this connection, there is a possibility that the un-reacted silver halide is changed to the metallic silver (developing silver) by the photo-irradiation at the time of photoelectric conversion by using the scanner.

In the present invention, the “image input medium” is, specifically, an image pick-up element (image sensor) having the photoelectric conversion function, and particularly, a photographing element (CCD type photographing element, hereinafter, simply called also “CCD”) in which the structure having the charge transfer mechanism called CCD (charge coupled device) is adopted in the shift register (charge transfer mechanism), is well known. In the CCD, there is a line-like one arranged one-dimensionally and an area type one arranged two-dimensionally. When the line-like CCD is used, the scanning mechanism by which the color negative film is conveyed in a predetermined direction and the whole of the photographing frame is read, is necessary, and also in order to shorten the time necessary for reading, in the present invention, it is preferable that the area-like CCD is used.

In the present invention, “the image input medium is scanned and read, and converted into the electric signal” means a process by which each pigment amount (“pigment image information”) of yellow, magenta, and cyan, which respectively corresponds to 3 primary color components of red, green and blue which is the object color (“Image”) information recorded in the color negative film and is generated, and the optical density information except each pigment amount (for example, infrared image information) are replaced with the electric signal information by using the image input medium, light source, and color separation filter.

In the present invention, a “predetermined image processing” indicates a processing by which, because the obtained electric signal information is the transmission information of the pigment density which simply the color negative film is colored, the optimum image quality is obtained on the silver halide paper, or output device such as a CRT monitor. Specifically, the negative positive reversal, gradation correction, luminance adjustment, color balance adjustment, granularity adjustment, or sharpness emphasis, is listed. Further, the information generated via “predetermined image processing” from the reading is called the “digital image data”.

Further, the “image input apparatus” is an apparatus structured by the apparatus such as, other than the “image input medium”, “light source” and “color separation filter”, the “film conveying mechanism” “image processing section”, “monitor display section” which transmits the digital image data to the CRT monitor image area, “interface section” for the user operation, “recording section” which transmits the digital image data to the apparatus in which digital image data is stored in the recording medium, and the other than that, the “power source section”. As the image input apparatus, it is the scanning apparatus (hereinafter, called also “film scanner”, “scanner”, or “flat bed scanner”), or an apparatus structured by the digital camera and close-up unit for the film photographing.

The “storage medium” is a memory in which the “digital image data” is stored, and the memory may also be any one of an image input apparatus main body, digital mini-lab on which the scanner is mounted, memory provided inside of the processing terminal to which the scanner is connected, or a portable memory such as a “MO” or “CD-R”.

In the image input apparatus of the first—sixth present invention, “added” means that it is recorded in the leading age portion (header) of the digital image data as a tag (code). As the regulation according to which the tag information is recorded, it is, for example, “Baseline Tiff Rev. 6.0 RGB Full Color Image” which is adopted as the non-compression file of the Exif file, and a compression data file format according to the JPEG format.

In the present invention, “the information showing that the film is scanned and it is generated, is added” means that, in the leading edge portion (header) of the digital image data, as the tag (code), it is recorded that it is scanned from the film. Further, the kind (kind of apparatus) of the image input apparatus may also be given as the tag information. Furthermore, the date and time at which the scanning is conducted, or place (shop), or operator name, may also be given as the tag information.

In the present invention, “the information relating to the film is added” means that In the leading edge portion (header) of the digital image data, as the tag (code), any one or more of the kind of the negative and positive, film size, ISO sensitivity, and film product name, is recorded. Further, the information relating top the film may also be either one of the method in which the scanner automatically reads from the film, or the method in which the operator manually inputs.

Furthermore, also the information read from the magnetic recording layer of the advanced photo system (hereinafter, called “APS”), as the information relating to the film, may also be added to the tag.

In the present invention, “the information used for the judgment when the digital image is generated is added” means that, in the leading edge portion (header) of the digital image data, as the tag (code), any one or more of the exposure condition (under, normal, over), rear-light, gray balance condition, or mask density, is recorded. Herein, “gray balance condition” is the sensitivity difference to respective BGR accompanied by the light source color temperature change at the time of photographing. Further, the “mask density” is the BGR density of the un-exposed portion.

In the present invention, “the information relating to the image processing set when the digital image data is generated is added” means that, in the leading edge portion (header) of the digital image data, as the tag (code), any one or more of the γ setting, color balance set, saturation adjustment, sharpness adjustment, granularity suppression or dust and flaw removal, is recorded.

In the present invention, “the information showing either of the automatic or manual one is the condition set for generating the digital image data, is added” means that, in the leading edge portion (header) of the digital image data, as the tag (code), the condition set for generating the digital image data is either of the automatic or manual one, is recorded.

In the present invention, “the information showing that it is scanned just after the development, or that the developed film brought-in by the customer is scanned, is added” means that, in the leading edge portion (header) of the digital image data, as the tag (code), it is scanned just after the development, or the developed film brought-in by the customer is scanned, is recorded. Further, the developing method of the film or the kind (kind of the apparatus) of the apparatus by which the film is developed, may also be given as the tag information. The developing method of the film is the liquid development processing, or the thermal developing processing by which the processing sheet including the developing agent, after the film is swelled by the water, is pasted up each other, and pressure contacted by the heat block or drum and heat processed, or LVTT, and may also include the development time or the existence or non-existence of the de-silverizing processing process. Further, the day and time at which the development is conducted, place (shop), and operator name may also be added as the tag information.

In the image output apparatus of the present invention, the “inputted digital image data” means the digital image data generated by the photographing means such as the digital camera, or the data in which the photographed image is converted into the digital image data by the film scanner, or flat bed scanner, or the digital image data in which these digital image data is processed or format-converted by each kind of application program, and generated. As the mode of the digital image data, the general purpose format represented by JPEG, TIFF, Exif, or kind of device, or the application proper format is listed as an example, and it is given to the image output apparatus of the present invention through a recording medium such as the hard disk, CD-ROM, memory card, and floppy (R) disk, or the communication line such as LAN, or the internet.

In the image output apparatus of the present invention, “a predetermined image processing is conducted and the digital image data for output is generated” means an action by which, when the image is observed on the output medium such as the print paper, so that more preferable impression is given, a predetermined image processing, which will be described later, is conducted on the inputted digital image data and the corrected digital image data is generated.

The generated digital image data for output is sent to the printer inside the apparatus or the printer connected through the communication line, as it is. Further, the format is converted by the general purpose format represented by JPEG, TIFF, and Exif, or kind of device, or application proper format, and may also be stored in the storage media such as the hard disk, CD-ROM, memory card, and floppy (R) disk, or transferred through the communication line.

As a “predetermined image processing” (hereinafter, called (the image processing in the image output apparatus of the present invention)), the gradation conversion, sharpness emphasis, granularity suppression, color balance set, saturation adjustment, dust and flaw removal, white balance, or γ setting, is listed, and these will be detailed below.

As the conception of respective processing methods which structure the image processing in the image output apparatus of the present invention, each kind of publicly known and used image processing method can be used. The following image processing method is, in the intermediate processing process in which the print is produced from the digital image data obtained by scanning the negative film, conducted on the digital image data.

The “gradation conversion” is one of non-linear conversion processing methods to be conducted so that the digital image data is more easily viewed, or the specific density is emphasized (contrast emphasis) and the useful information is obtained. The digital image data is divided into the pixel, and because the pixel is a numeric value of the image density of that portion, the numeric value can be changed by the calculation. When the contrast of the image is low, the density difference of the whole is increased and the contrast is increased when the value of the pixel of the shoulder portion (high light portion) is reduced, and the value of the pixel of the leg portion (shadow portion) is increased. This calculation is conducted according to a predetermined rule, and normally, the conversion method is shown in the form of the function.

When the function matched with the purpose of use (for example, for the negative film, for the reversal film) is used, because the density region in which the dimension of the contrast of the image or the contrast is changed, can be selected, the necessary image can be freely produced. When not only the highlight side or shadow side, but the value of the pixel of the intermediate portion is also changed, the lightness of the whole image is adjusted. The gradation conversion processing to the digital image data obtained by scanning of the negative film is the gradation reversal processing, contrast increase processing, or correction to the exposure condition (under, normal, over), and the processing largely depending on the input device structure such as the camera performance or film characteristic, and the exposure condition at the time of photographing. Other than this, the method of the gradation conversion such as the histogram method or filtering is used.

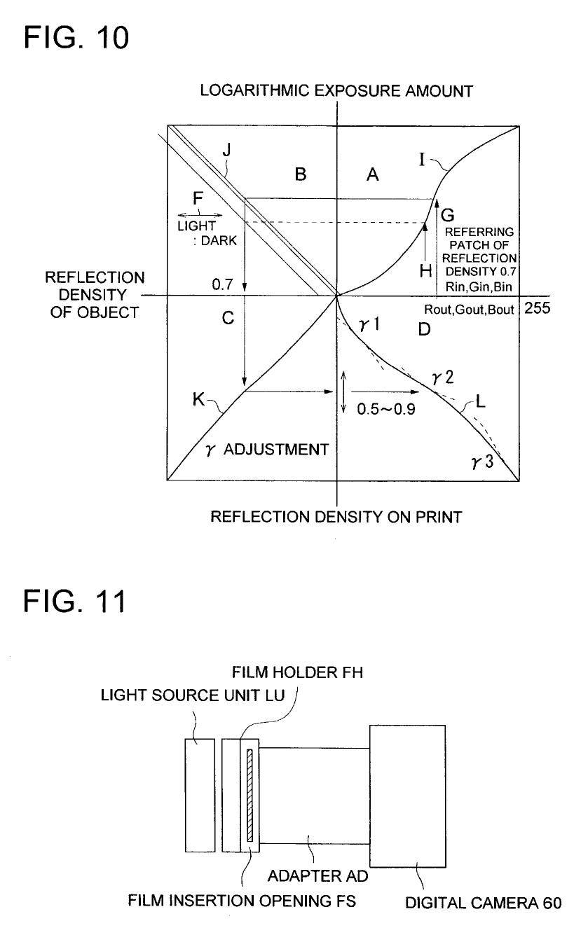

Referring to the drawing, an example of the gradation conversion method will be detailed below. FIG. 10 is a view for explaining an example of the gradation conversion method.

In FIG. 10, a curve (I) of the first quadrant is a curve by which the logarithmic exposure amount of the digital image data obtained by scanning the negative film is obtained. A straight line (J) of the second quadrant (B) is one for adjusting the lightness of the whole image, and when it is moved in parallel in the arrowed direction shown by F, it is adjusted. A curve (K) of the third quadrant (C) is a curve for adjusting the γ setting, color balance, and saturation. A curve (L) of the fourth quadrant (D) shows the γ setting reproduced on the print. A point G shown by an arrow on the curve (I) shows the value (Rin, Gin, Bin) of the image data in which the gray object of the reflection density 0.7 (reflective factor is 18%) is photographed. This point expresses the refraction density 0.7 of the object by the straight line (J) of the second quadrant, and shows that this condition is the basic condition of the straight line (J).

Because, by the curve (K) of the third quadrant, the gradation characteristic to reproduce on the print is determined, when the curve (K) is set to the straight line of γ=1, the gradation characteristic truly expressing the reflection density is obtained on the print. Further, when γ of the leg portion (shadow portion), abdomen portion, shoulder portion (highlight portion) of the curve (K) is adjusted, and γ1 (leg portion (shadow portion) γ), γ2 (abdomen portion γ), and γ3 (shoulder portion (highlight portion) γ) shown in the curve (L) are set to the arbitrary value, the desired gradation characteristic on the print can be obtained. The parallel movement amount in the arrowed direction shown by F is calculated in the straight line (J) of the second quadrant (B) so that the average value of the image data has the reflection density of 0.7 on the output medium. The average value of the image data is calculated, and this value is made the point H shown by an arrow on the curve (I). Because the point H is varied depending on the object, by the parallel movement of the straight line (J), it is adjusted so as to conform to the reflection density 0.7 of the object. The γ of the curve (K) is set so that γ of the leg portion (shadow portion) and shoulder portion (highlight portion) is smaller than γ of the abdomen portion.

As the method to calculate the average value of the image data, for example, there is method (Expression 1) in which the color phase and saturation are close to each other and the mutual adjoining pixels are extracted as the same group, and from the simple average of each group and the number of pixels, the whole density is calculated.

A₀=ΣA(j)·F(N(j))/F(N(j)) (Expression 1)

where, A₀=average value, A(j): the average density of the group j, N(j): the number of pixels of group j.

Like as the strobe close-up photographing or rear-light scene, when the print from the digital image data obtained by scanning the negative film in which the photographing scene whose the distribution range (hereinafter, called also “gradation range”) of the object luminance is broad is recorded, is produced, the compression operation of the gradation range called dodging is conducted.

As the applied example of the histogram method, it will be detailed below. Initially, relating to the image of the lightness information, the histogram of the lightness and its frequency of occurrence is generated. For the generated histogram, the image judgment processing is conducted, and the block of the frequency of the occurrence relating to this lightness is divided into a plurality of blocks. In this case, by using the discriminant regulation method, the threshold value is set and divides it into more than 2 blocks. As the method by which the original image is divided into a plurality of blocks or groups, as disclosed in Japanese Tokkaihei No. 11-284860, there is the method by which, based on the data relating to the luminance of the original image, the discriminant regulation method is applied to the histogram and the threshold value of the data relating to the luminance is found, and divided.

Other then that, as a method for finding the threshold value, there is a method for finding the threshold value from the shape of the crest or trough of the histogram, the shape of the accumulation density function, or inflection point. Further, the method may also be used by which, by using the method such as the in-image plane edge detection, range detection, or pattern matching, the original image is divided into a plurality of blocks, or the method may also be used by which the threshold value of the luminance is found from the shape of the histogram or accumulation density function, and the original image is roughly divided into a plurality of ranges, and further, by using the method such as the in-image area edge detection, range detection or pattern matching, the range boundary is finely set.

In this case, the data relating to the average value of the data relating to the luminance of the image data in a predetermined range or the central value is found, and from these relationship, the correction value corresponding to respective blocks may be found. Next, from the shape of the histogram, several crests or troughs between them are detected. Then, the trough by which the highlight side and the shadow side are divided, is found, and a portion of this trough is made a division point. The image in which the lightness of the division point is made a threshold value and binarized, is made from the image of the lightness information, and further, this binarized image is reversed, and the original mask is generated. Next, the blurred filter processing of about 3 ×3-5×5 is conducted on the original mask, and the plural n-times of blurred processing are repeatedly conducted so that it is about a degree in which it has an appropriate blur as the dodging mask. By using the generated dodging mask, the compression operation of the gradation range is conducted.

In the present invention, the “sharpness emphasis” is an image processing conducted for emphasizing the profile (edge) of the image, or conducted for more easily viewing the digital image data, or conducted for preventing the image from deteriorating. As a general method of the “sharpness emphasis”, an un-sharp masking processing is listed. This method is the processing by which, by conducting the operation for subtracting the blurred image from the original image, the contrast of the edge existing portion is increased. The un-sharp masking processing is shown by the following expression.

y(i, j)=s(i, j)−h(s(i, j))

Herein, h(s(i, j)) means a Laplacian processing. y(i, j) expresses the value of the sharpness image on which the un-sharp masking is conducted, of the pixel specified by i=1−i, h=1−j. s(i, j) expresses, for the image data whose image size is i×j, the value of the sharpness image before the un-sharp masking processing is conducted, of the pixel specified by i=1−i, h=1−j. (s(i, j)) expresses, for the image data whose image size is i×j, the value of the blurred image on which Laplacian processing is conducted, of the pixel specified by i=1−i, h−1−j.

In the case of the image data on which the noise is superimposed, because the noise portion is emphasized, it is preferable that only the specific frequency area is extracted by the extension processing by which the noise is not emphasized, processing by which the sharpness emphasis is conducted while filtering processing the noise, Fourier conversion, or wavelet processing, and the processing by which the sharpness emphasis is conducted is used.

In the present invention, the “granularity suppression ” is the image processing by which the noise emphasized by the film granularity, electric noise of the apparatus, or sharpness emphasis is reduced, and the grade of the digital image data is increased. As the general method of the granularity suppression, a moving average method, median (central value) filter, selective local averaging, or smoothing method of the removal processing of the isolated noise, is listed. The median filter is the smoothing method by which the median of the density (pixel value) in the local area is given as the output density, that is, when 3×3 area is used, 9 density values are arranged in the order of small value, and 5-th (central) density value from the smallest value is made the output density. By the granularity suppression processing, because the contrast of the profile (edge) of the image is lowered, it is preferable that only the specific frequency region is extracted by the non-linear filter such as the median filter, the shape of the local area, space filter processing by which the dimension is changed corresponding to the granularity condition, or Fourier conversion, wavelet processing, and the processing by which the granularity suppression is conducted, is used.

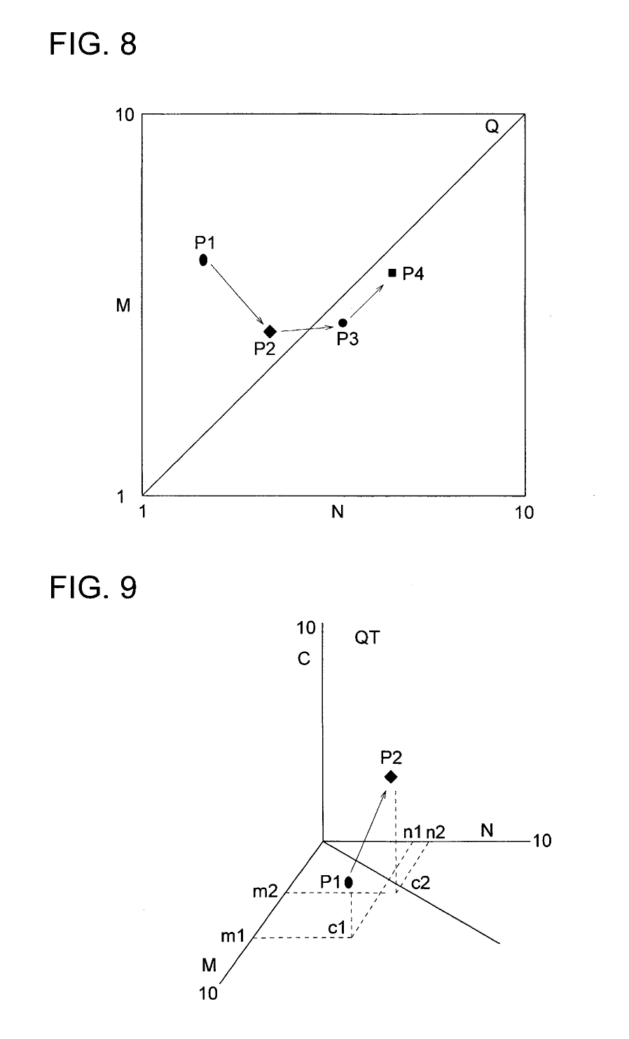

As described above, the sharpness emphasis and the granularity characteristic influence each other. In order to regulate the well balanced processing amount, it is preferable that, by using the evaluation scale regulated by the functional value, respective processed amounts are determined. Referring to FIG. 8 and FIG. 9, the image processing in the embodiment of the present invention will be further detailed. FIG. 8 is a view showing the adjustment of the sharpness and granularity processing amount. A sign M is shown by the following expression. The sharpness degree of each luminance is obtained by the following expression, when the power spectrum obtained when image is frequency-analyzed, is plotted to the frequency, and the inclination per unit obtained by connecting 2 points of 10 cycle/mm and 20 cycle/mm is mg, and mr.

M=7.0×log 10(mg×29.4+mr×12.6+40)−10.

Sign N is the average value of the standard deviation in which the image is averaged in each small block, and in Green and Red, is made respectively SDg and SDr. The granularity is calculated from respective numerals in SDg and Sdr, and ng and nr are found from the following expressions, and as the average value, it is calculated by N=(7×ng+4×nr)/11.

ng=−7.0×log 10(9.9×SDg−11)+15.5

nr=−7.0×log 10(9.9×SDr−11)+15.5

From the value of M and N calculated as above, the overall image quality value (Q) is calculated by the following expression.

Q={(0.413×M^{(-3.4)}+0.422×N^{(-3.4)})^{(-3.4)}}−0.532

By maintaining the Q value in a predetermined range, the balance between the sharpness and granularity of the digital image is maintained.

In FIG. 8, sign P1 shows an initial value calculated from the digital image data. Sign P2 shows the film information obtained by the header information analysis, specifically, the target value to be corrected according to the product name. Sign P3 shows the scanner judgment information obtained by the header information analysis, specifically, the target value to be corrected according to the exposure condition. Sign P4 shows the image processing set information obtained by the header information analysis, specifically, the target value to be corrected according to the sharpness adjustment information, and granularity suppression information.

FIG. 9 is a view showing the adjustment of the sharpness, granularity, and saturation processing amount. The coordinates (m1, n1) of the surface regulated by the MN axis of P1 and the coordinates (m2, n2) of the surface regulated by the MN axis of P2 respectively correspond to P1 and P2 in FIG. 8. FIG. 9 is also a conceptual view showing that the saturation is further monitored by the value on the C axis, and that the balance of each image processing amount is adjusted by the 3 dimensional overall image quality value (QT value).

In the present invention, the “color balance set” is an image processing for correcting the sensitivity difference to respective of BGR accompanied to the light source color temperature change at the time of photographing. Thereby, the gray of the object is reproduced to the gray also in the digital image data or on the output medium. When the color balance set exceeds a predetermined range, the possibility that the light source at the time of photographing is an artificial light source whose color temperature is extremely low such as a fluorescent lamp, or tungsten, sodium lamp, is high, and to such a digital image data, it is not preferable to intense the saturation emphasis because the separation from the actual observation condition by the human visual sense is increased.

In the present invention, the “saturation adjustment” is one of the image processing by which the saturation is approximated to the saturation of the object, or approximated to the saturation which is subjectively preferable (the saturation of the so-called memory color) As a method, a method of the matrix calculation in which, between RGB value of the pixel, a predetermined coefficient is multiplied, and subtraction processing is conducted, a method by which it is converted into the Lab color space (color specification system) which is expressed by the luminance, saturation and pigment, and the color reproduction range in the 2 dimensional space is adjusted, or a method by which the look-up table is referred and converted into the pixel value which expresses the high saturation, is listed. Accompanied to the gradation conversion processing, also the saturation is changed. Further, by also the sharpness emphasis, the saturation is highly increased. Accordingly, when the gradation conversion or sharpness emphasis is made preprocessing, it is necessary that, corresponding to the degree of the preprocessing, the saturation adjustment amount is corrected. Further, in the same manner as the balance between the sharpness and the granularity in the overall image quality value (Q value), also in the saturation, the influence to the whole image quality is large.

By using only the data within the range of the (color phase angle (degree) ±10) in each color of the color chart of blue, green, red, yellow, magenta, and cyan of the Macbeth chart, the chroma average value of each color in B, G, R, Y, M, C is found, and on the one hand, the chroma calculated from the Macbeth color chart data, is found in each color of B, G, R, Y, M, C, and the ratio to the chroma of Macbeth is calculated in each color, and CrO is found, and calculated as the following.

C=20×log 10(CrO)

The 3 dimensional overall image quality value is expressed by the following expression.

QT=(Q+C)/2

When the QT value is maintained within a predetermined range, the balance among the sharpness and granularity and chroma of the digital image data is maintained.

In the present invention, “dust and flaw removal” is the image processing by which the infrared ray is irradiated on the film, and the dust and flaw are detected, and the information relating to the position is obtained together with it, and this is corrected. In the correction methods, there is a method by which, by using the pixel value in the periphery of the dust and flaw position, the pixel value of the dust and flaw position is corrected, or a method in which the infrared image information is directly used for the interpolation. The “white balance adjustment” is the same meaning as the “color balance set”, however, specifically, it indicates the automatic correction conducted in the camera at the time of photographing. The “γ setting” is γ value of the digital image data determined by the “gradation conversion”. The γ setting is defined as at least 3 of the leg portion (shadow portion), dormant portion (intermediate portion), and shoulder portion (highlight portion).

Further, in the present invention, the “means for judging whether it is an image generated by scanning the film” is a software (program) to analyze the information expressing whether it is an image generated by scanning the film, which is recorded as the tag (code) in the leading edge portion (header) of the digital image data.

In the present invention, “Based on the judged result, the content and set of the image processing relating to the image output is changed” means that, when the information expressing that it is an image generated by scanning the film is recorded as the tag (code) in the leading edge portion (header) of the digital image data, the content and set of the image processing to be conducted on the digital image data is changed to one previously prepared for the image generated by scanning the film. Further, “based on that judged result, the content and set according to the image output are changed” is at least one of the gradation conversion, sharpness emphasis, granularity suppression, color balance set, saturation adjustment, and dust and flaw removal.

In the present invention, the “means for obtaining the information relating to the film” is a software (program) to analyze the information expressing one or more of the kind of negative or positive, film size, ISO sensitivity, and film product name, which is recorded as the tag (code) in the leading edge portion (header) of the digital image data. Further, “according to at least one of the information from the two means, the content and set of the image processing relating to the image output are changed” means that, when the information expressing any one or more of the kind of negative or positive, film size, ISO sensitivity, and film product name, is recorded as the tag (code) in the leading edge portion (header) of the digital image data, the content and set of the image processing conducted on the digital image data are changed to one previously prepared for each kind of negative or positive, film size, ISO sensitivity, and film product name. Further, in Item 14, the “content and set of the image processing relating to the image output” is at least one of the gradation conversion, sharpness emphasis, granularity suppression, color balance set, and saturation adjustment.

The “content to change the content and set of the image processing relating to the image output according to at least one of the information from the two means” is any one or more of the following 6 items.

(1) In the granularity suppression set of the image from the negative film, the granularity suppression degree is higher than the granularity suppression set of the image from the positive film.

(2) In the gradation correction set of the image from the negative film, the non-linearity degree is higher than the gradation correction set of the image from the positive film.

(3) In the granularity suppression set of the image from the film whose film size is small, the granularity suppression degree is higher than the granularity suppression set of the image from the film whose film size is large.

(4) In the granularity suppression set of the image from the film whose ISO sensitivity is high, the granularity suppression degree is higher than the granularity suppression set of the image from the film whose ISO sensitivity is low.

(5) In the saturation emphasis set of the image from the film whose ISO sensitivity is high, the emphasis degree is higher than the saturation emphasis set of the image from the film whose ISO sensitivity is low.

(6) According to the film product name, at least one of the gradation conversion, sharpness emphasis, granularity suppression, color balance set, and saturation adjustment, is changed.

In the present invention, the “means for obtaining the information used for the judgment when the digital data is generated” is a software (program) to analyze the information expressing any one or more of the exposure condition (under, normal, over), rear-light, gray balance condition, and mask density, which is recorded as the tag (code),in the leading edge portion (header) of the digital image data. Further, the content and set of the image processing is at least one of the gradation conversion, sharpness emphasis, granularity suppression, color balance set, saturation adjustment, and white balance adjustment. Further, as the content of “the content and set of the image processing relating to the image output are changed”, it is one or more of the following 4 items.

(1) The non-linearity of the gradation correction according to the exposure condition (under, normal, over) is changed.

(2) The non-linearity of the gradation correction in the case of the rear-light is increased.

(3) When the value of the color balance condition is not within a predetermined range, the saturation emphasis is suppressed.

(4) When the mask density processing method is based on the assumed value, as compared to the case where the mask density processing method is according to the actual measurement, the degree of the white balance adjustment is increased.

In the present invention, the “means for obtaining the information relating to the image processing set” is a (software) program to analyze the information expressing any one or more of the γ setting, color balance set, saturation adjustment, sharpness adjustment, granularity suppression, and dust and flaw removal, which are recorded as the tag (code) in the leading edge portion (header) of the digital image data. Further, the “content and set of the image processing relating to the image output” is any one or more of the γ setting, color balance set, saturation adjustment, sharpness adjustment, granularity suppression, and dust and flaw removal. Further, as the content of “the content and set of the image processing relating to the image output are changed”, it is any one or more of the following 6 items.

(1) Referring to the information of the γ setting when the digital image is generated, the γ setting of the image processing relating to the image output is changed.

(2) Referring to the information of the color balance set when the digital image is generated, the color balance set of the image processing relating to the image output is changed.

(3) Referring to the information of the saturation adjustment set when the digital image is generated, the saturation adjustment set of the image processing relating to the image output is changed.

(4) Referring to the information of the sharpness adjustment set when the digital image is generated, the sharpness adjustment set of the image processing relating to the image output is changed.

(5) Referring to the information of the granularity suppression set when the digital image is generated, the granularity suppression set of the image processing relating to the image output is changed.

(6) Referring to the information of the dust and flaw removal set when the digital image is generated, the dust and flaw removal set of the image processing relating to the image output is changed.

In the present invention, the “means for obtaining the information showing either of automatic or manual one is the condition set for generating the digital image data” is a software (program) to analyze the information expressing that either of automatic or manual one is the condition set for generating the digital image data, which is recorded as the tag (code) in the leading edge portion (header) of the digital image data. Further, “the content and set of the image processing relating to the image output are changed” is that, when the condition set for generating the digital information expressing the image is manual, at least one of the γ setting, color balance set, saturation adjustment, sharpness adjustment, and granularity suppression, in the image processing relating to the image output, is suppressed.

In the present invention, the “means for obtaining the information showing that the film is scanned just after the development, or the developed film brought-in by the customer is scanned” is a software (program) to analyze the information expressing that the film is scanned just after the development, or the developed film brought-in by the customer is scanned, which is recorded as the tag (code) in the leading edge portion (header) of the digital image data. Further, as the content of “the content and set of the image processing relating to the image output are changed”, either one or both of the following 2 items.

(1) When the developed film brought-in by the customer is scanned, the dust and flaw removal of the image processing relating to the image output is intensified.

(2) When the developed film brought-in by the customer is scanned, at least one of the γ setting, color balance set, and saturation adjustment, in the image processing relating to the image output, is suppressed.

Referring to the drawings, the embodiment of the present invention will be described below.

FIG. 11 is a view showing an embodiment of an image input apparatus of the present invention. The situation in which a film holder FH is attached to a digital camera 60 through an adapter AD, is shown. The film holder FH is provided with a film insertion opening FS and a light source unit LU. The light source unit LU is detached and the transmitted light information of the film can also be obtained by using an indoor illumination device or sunlight.

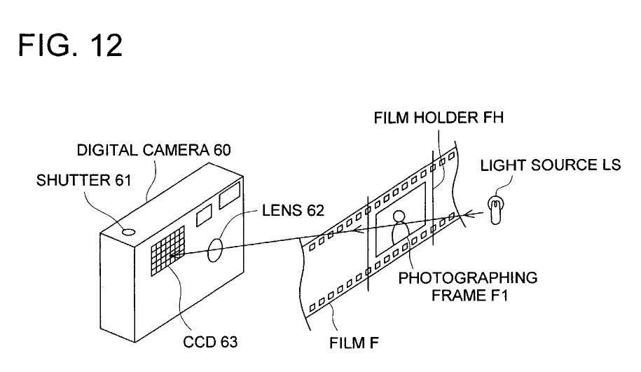

FIG. 12 is a view showing an embodiment of the image input using the image input apparatus of the present invention. The film holder FH is attached to the digital camera 60 through the adapter (not shown). The film F is set in the film holder FH, and the photographing frame F1 is positioned. By the light source LS, the transmitted light information from the film F is image-formed on a CCD 63 through a lens 62 of the digital camera 60. The Light source LS is a strobe light source which emits the light being interlocked with a shutter 61 of the digital camera. The light source LS has the scattering plate so that the photographing frame F1 is uniformly illuminated. A flash light source is generated by a xenon flash tube, or high luminance LED.

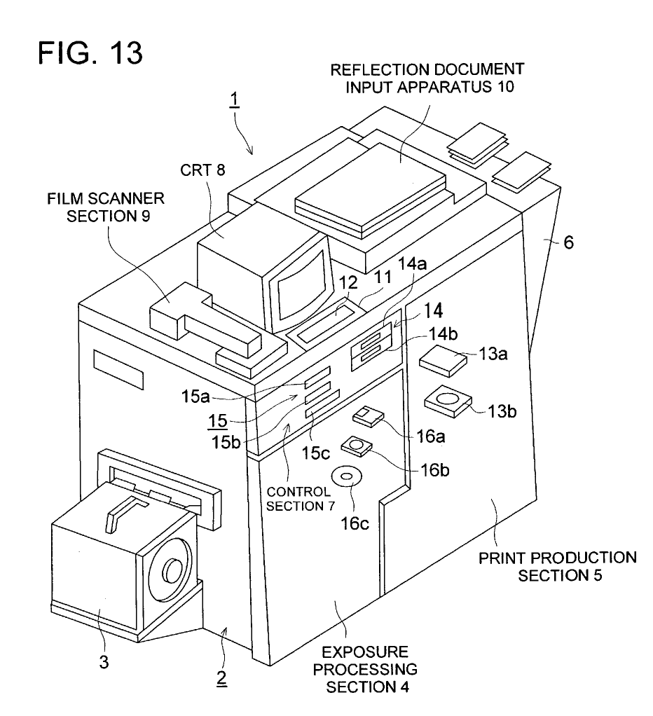

FIG. 13 is a conceptual view showing an image recording apparatus of the present invention. The image recording apparatus 1 is structured by the image input apparatus and image output apparatus. In FIG. 13, as the image output apparatus, an apparatus by which a photosensitive material is exposed, developed, and the print is generated, is shown. However, as the image output apparatus, it is not limited to this, but when it is an apparatus by which the print can be produced according to the image information, any one may be allowed, for example, it may also be a print producing apparatus such as an inkjet system, electro-photographic system, heat sensing system, or sublimation system.

The image recording apparatus 1 is provided with a magazine loading section 3 on the left side surface of the main body 2, and in the main body 2, an exposure processing section 4 which exposes the photosensitive material which is the recording medium, and a print producing section 5 by which the exposed photosensitive material is development processed and dried, and the print is produced, are provided, and the produced print is delivered on a tray 6 provided on the right side surface of the main body 2. Further, in the inside of the main body 2, a control section 7 is provided on the upper position of the exposure processing section 4. Further, above the main body 2, a CRT 8 is arranged. This CRT 8 structures a display means for displaying the image of the image information in which the print is to be produced, on the image area.

A film scanner section 9 which is a transmission document reading apparatus is arranged on the left side of a CRT 8, and on the right side, a reflection document input apparatus 10 is arranged. As a document read from the film scanner section 9 or the reflection document input apparatus 10, there is a photographic photosensitive material. As this photographic photosensitive material, the color negative film, color reversal film, monochromatic negative film, or monochromatic reversal film, is listed, and the frame image information which is image-picked-up by the analog camera, is recorded. By the film scanner of the film scanner section 9, it is converted into the digital image data, and can be the frame image data. Further, when the photographic photosensitive material is the color paper, it can be converted into the frame image data by the flat bed scanner of the reflection document input apparatus 10.

At the position of the control section 7 of the main body 2, an image reading section 14 is provided. The image reading section 14 is provided with a PC card adapter 14a and floppy (R) disk adapter 14b, and into the section, the PC card 13a or floppy (R) disk 13b can be inserted. The PC card 13a has a memory in which a plurality of frame image data which are image-picked-up by the digital camera are stored. In the floppy (R) disk 13b, a plurality of-frame image data which are image-picked-up by, for example, the digital camera are stored. On the front side of the CRT 8, an operation section 11 is arranged, and in this operation section 11, an information input means 12 is provided, and the information input means 12 is structured by, for example, a touch panel.

As a recording medium having the frame image data according to the present invention except the above description, a multimedia card, memory stick, MD data, and CD-ROM are listed. In this connection, the operation section 11, CRT 8, film scanner section 9, reflection document input apparatus 10, and image reading section 14 are integrally provided in the main body 2, and is the structure of the apparatus, however, any one or more may also be provided as the separated body. Further, in the position of the control section 7 of the main body 2, an image writing section 15 is provided. In the image writing section 15, a FD adapter 15a, MO adapter 15b, and optical disk adapter 15c are provided, and a FD 16a, MO 16b, and optical disk 16c can be inserted in it, and the image information can be written in the image recording media. Further, in the control section 7, the communication means, not shown, is provided, thereby, from the other computer in the facility or the remote computer through the internet, the image data expressing the image-picked-up image and the print command are directly received, and it can function as so called a network image output apparatus.

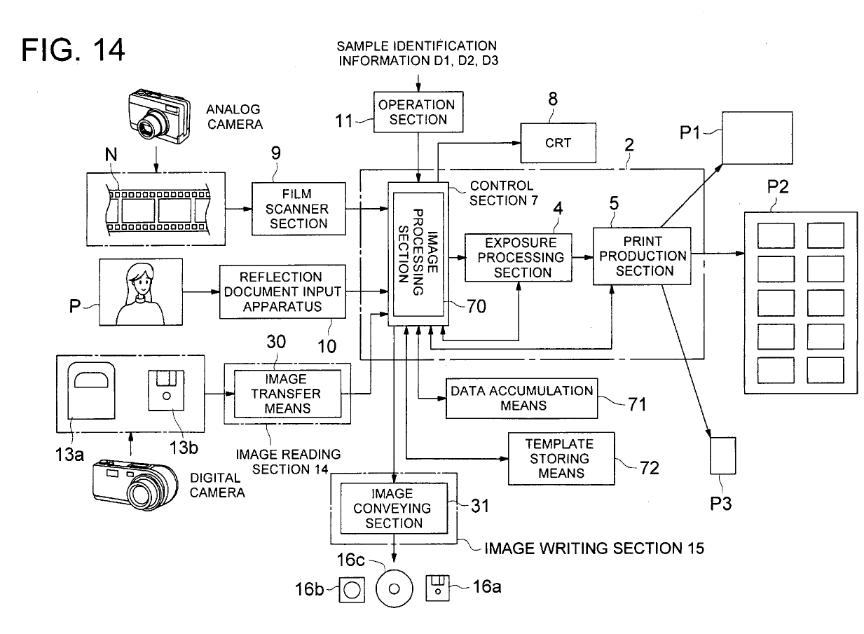

FIG. 14 is a block diagram showing the structure of the embodiment of the image recording apparatus 1. The control section 7 of the image recording apparatus 1, according to the command information from the information input means 12, reads the document information from the film scanner section 9 or reflection document input means 10, obtains the image data, and displays it on the CRT 8. Further, the image recording apparatus 1 has the data accumulation means 71 and the template storage means 72. In the data accumulation means 71, the image information and the order information corresponding to it (the information how many prints are produced from the image of which frame, and the print size information) are stored, and successively accumulated. From the film scanner section 9, the frame image data is inputted from the developed negative film N obtained by developing the negative film which is image-picked-up by the analog camera, and from the reflection document input apparatus 10, the frame image data from the print P in which the frame image is printed on the print paper and developing processed is inputted.

In the template storage means 72, the data of at least one template by which a background image and illustration image which are the sample image data, corresponding to the sample identification information D1, D2, and D3, and the synthetic range are set, is previously stored. A predetermined template is selected from a plurality of templates which are set by the operation of the operator and previously stored in the template storage means 72, and the frame image information is compounded by the selected template, and the sample image data selected according to the specified sample identification information D1, D2 and D3, and/or the character data are compounded, and the print according to the specified sample is produced. This composition by the template is conducted by the well known chromakey method.

The control section 7 has the image processing section 70, and the image data is image processed in the image processing section 70, and the output image data is generated and sent to the exposure processing section 4. In the exposure processing section 4, the image is exposed on the photosensitive material, and the photosensitive material is sent to the print producing section 5, and the photosensitive material exposed in the print producing section 5 is developing processed and dried, and the print P1, P2, and P3 are produced. The print P1 is a service size, high-vision size, or panorama size, and the print P2 is an A4 size print, and the print P3 is a name card size print.

In this image recording apparatus 1, there is provided an image reading section 14 by which the frame image data of the PC card 13a or floppy (R) disk 13b which is image-picked-up by the digital camera and stored, is read out and transferred. In the image reading section 14, as the image transfer means 30, the PC card adapter, and floppy (R) disk adapter are provided. Into the PC card adapter 14a, the PC card 13a is inserted, and into the floppy (R) disk adapter 14b, the floppy (R) disk 13b is inserted, and the frame image data recorded in the PC card 13a or floppy (R) disk 13b is read, and transferred to the control section 7 structured by a microcomputer. As the PC card adapter 14a, for example, a PC card reader or PC card slot is used.

In this image recording apparatus 1, it is structured in such a manner that the sample identification information D1, D2, D3 to specify the sample of the print are inputted from the operation section 11. However, because the sample identification information D1, D2, D3 are recorded in the sample of the print or order sheet, they can be read by the reading means such as the OCR, or they can also be inputted from the key board by the operator. Further, in the image processing section 70, the communication means, not shown, is provided, and from the remote computer through the other computer in the facility or the internet, the image data expressing the image-picked-up image and the operation command such as print are directly received, and by the remote operation, the image processing is conducted, and the print can also be produced.

In this manner, the sample image data is recorded corresponding to the sample identification information D1 to specify the sample of the print, and the sample identification information D1 to specify the sample of the print is inputted, and according to this inputted sample identification information D1, the sample image data is selected, and this selected sample image data and the image data and/or character data based on the order are compounded, and the print is produced according to the specified sample, therefore, the user can actually have various samples of the size of the original, and can order the print, and this system can correspond the various requirements of very wide users.

Further, the first sample identification information D2 to specify the first sample, and the first sample image data are stored, and the second sample identification information D3 to specify the second sample, and the second sample image data are stored, and the sample image data selected according to the specified first and second sample identification information D2 and D3, and the image data and/or character data based on the order are compounded, and the print based on the specified sample is produced, therefore, further various images can be compounded, and the prints corresponding to the various requirements of further wide users can be produced.

The image writing section 15 is provided with the FD adapter 15a, MO adapter 15b, and the optical disk adapter 15c are provided as an image conveying section 31, the FD 16a, MO 16b and optical disk 16c can insert into them, and the image data can be written in the image recording media.

Further, by using the communication means, not shown, connected to the image processing section 70, the image data expressing the photographing image after the image processing of the present invention is conducted, and the order information attached to it, can also be transmitted to the other computer in the facility or the remote computer through the internet.

As described above, the image recording apparatus 1 has an image input means for taking-in the image information obtained by the separation photometry of the image of each kind of digital media and the image document, and an image processing means by which the image information of the input image taken-in form this image input means is processed, when the information of “the dimension of the output image” and “the dimension of the main object in the output image” is obtained or assumed, and the image is observed on the output media, so that the image which gives the preferable impression to the users is produced, and an image output means by which the processed image is displayed, or print-outputted, or written into the image recording media, and a means for transmitting the image data and the order information attached to that, to the other computer in the facility through the communication line, or the remote computer through the internet.

The image input means is structured by the image reading section 14, film scanner section 9 by which the image document is subjected to the separation photometry and the obtained image information is taken-in, reflection document input apparatus 10, and communication means, not shown. Further, the image processing means by which the processing is conducted, when the information of “the dimension of the output image” and “the dimension of the main object in the output image” is obtained or assumed, and the image is observed on the output media, so that the image which gives the preferable impression to the users is produced, is provided in the image processing section 70, and the image output means is structured by the CRT 8 for displaying the image, exposure processing section 4 for print-outputting, print producing section 5, image writing section 15 for writing in the image recording media, and communication means, which is not shown.

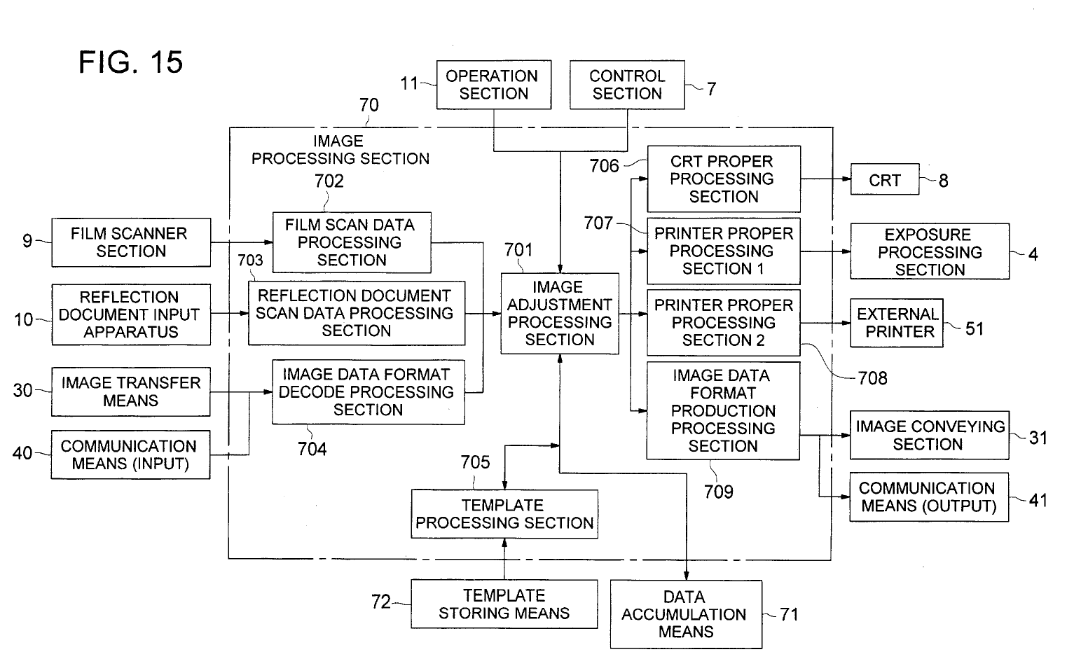

FIG. 15 is a block diagram showing the structure of the embodiment of the image processing section 70 according to the present invention. The image data inputted from the film scanner section 9 is subjected to, in the film scan data processing section 702, the correction operation inherent to the film scanner section, negative and positive reversal in the case of the negative document, dust and flaw removal, gray balance adjustment, contrast adjustment, granularity noise removal, and sharpness emphasis, and sent to the image adjustment processing section 701. Further, the film size, kind of negative and positive film, the information relating to the main object optically or magnetically recorded in the film, and the information relating to the photographing condition (for example, the content of the information written in APS), are sent together to the image adjustment processing section 701.

The image data inputted from the reflection document input apparatus 10 is, in the reflection data scan data processing section 703, subjected to the correction operation inherent to the reflection document input apparatus, negative and positive reversal in the case of the negative document, dust and flaw removal, gray balance adjustment, contrast adjustment, noise removal, and sharpness emphasis, and sent to the image adjustment processing section 701.

The image data inputted from the image transfer means 30 and communication means (input) 40 is, in an image data format decoding processing section 704, the conversion of the expressing method of the restoration and color data of the compressed code is conducted at need according to the data format of that data, and it is converted into the data format appropriate to the calculation in the image processing section 70, and sent to the image adjustment processing section 701. Further, the information relating to the main object obtained from the header information and tag information of the image data and the information relating to the photographing condition are sent together to the image adjustment processing section 701.

Other than this, in the form to supplement and replenish the information relating to the main object from the film scanner section 9, reflection document input apparatus 10, image transfer means 30, and communication means (input) 40 and the information relating to the photographing condition, the information can also be sent from the operation section to the image adjustment section 701.

The specification about the dimension of the output image is inputted from the operation section 11, and when, other than that, there is the specification relating to the dimension of the output image sent to the communication means (input) 40, or the specification relating to the dimension of the output image embedded in the header information and tag information of the image data obtained by the image transfer means 30, the image data format decoding processing section 704 detects the information, and transfers to the image adjustment processing section 701.

In the image adjustment processing section 701, when the template processing is necessary, the predetermined image data (template) is called from the template storing means 72. The image data is transferred to the template processing section 705, and composed with the template, and the image data after the template processing is received again. Further, in the image adjustment processing section 701, according to the command of the operation section 11 or control section 7, to the image data received from the film scanner section 9, reflection document input apparatus 10, image transfer means 30, communication means (input) 40, and template processing section 705, the image processing is conducted so that the image is produced which gives the preferable impression to the users when the image is observed on the output media by the method which will be described later, and the digital image data for output is generated, and sent to the CRT proper processing section 706, printer proper processing section (1) 707, image data format production processing section 709, and data accumulation means 71.

In the CRT proper processing section 706, on the image data received from the image adjustment processing section 701, the processing such as the change of the number of pixels or color matching is conducted at need, and the image data for the display composed with the information in which the control information display is necessary, is sent to the CRT 8. In the printer proper processing section (1) 707, the correction processing proper to the printer, color matching, or change of the number of pixels is conducted at need, and the image data is sent to the exposure processing section. When the external printer apparatus 51 such as the large sized inkjet printer is further connected to the image recording apparatus 1 of the present invention, for each of the connected printers, the printer proper processing section (2) 708 is provided, and the appropriate correction processing proper to the printer, color matching, or change of the number of pixels is conducted.

In the image data format production processing section 709, on the image data received from the image adjustment processing section 701, the conversion to the each kind of general use image format represented by the JPEG, TIFF, or Exif is conducted at need, and the image data is transferred to the image conveying section 31 or communication means (output) 41.

The above-described division of the film scan data processing section 702, reflection document scan data processing section 703, image data format decode processing section 704, image adjustment processing section 701, CRT proper processing section 706, printer proper processing section (1) 707, printer proper processing section (2) 708, and image data format production processing section 709, is a division provided to help the understanding of the function of the image processing section 70 according to the present invention, and it is not always necessary that it is realized as the physically independent device, but also it may be realized as a division of, for example, the kind of the software in the single CPU.

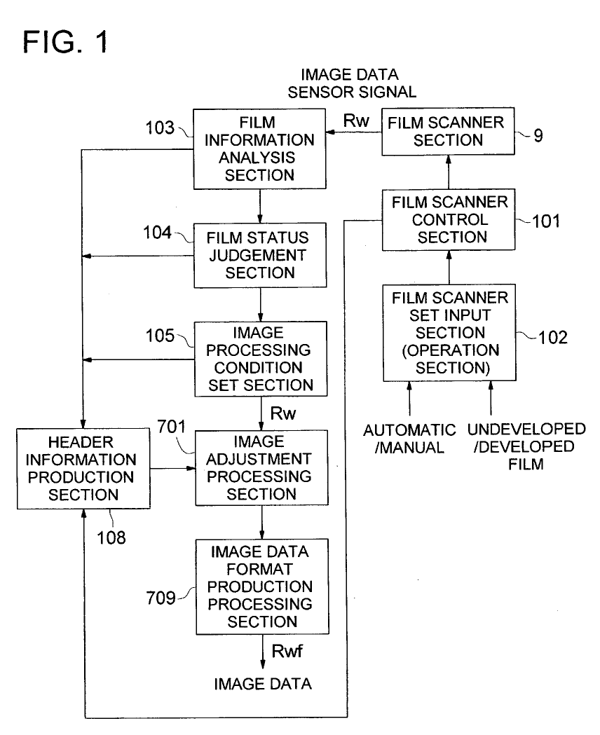

FIG. 1 is a block diagram for explaining the function of the film san data processing section in the image processing section 70 according to the present invention.

The user or operator inputs the scanning condition of the film from a film scanner set input section (operation section) 102. According to the set information, the film scanner control section 101 sends the control signal to the film scanner section 9 and the scanning the film is conducted. The film scanner section 9 transmits the original signal (Rw) of the obtained digital image signal and the signal received by the sensor to a film information analysis section 103. In the film information analysis section 103, the kind of the negative and positive film, film size, ISO sensitivity, and film product name are analyzed by the sensor signal from a side mark of the film (DX cord) or magnetic information, and the coding processing for recording it as the tag (code) in the leading edge portion (header) of the digital image data is conducted.

Next, in a film condition judgment section 104, the exposure condition (under, normal, over), rear-light, gray balance condition, or mask density, is analyzed by the original signal (Rw), and the coding processing for recording it as the tag (code) in the leading edge portion (header) of the digital image data is conducted. Next, in an image processing condition setting section 105, existence or not of the image processing such as the γ setting, color balance set, saturation adjustment, sharpness adjustment, granularity suppression, and dust and flaw removal, or the processing amount is determined, and the coding processing for recording these image processing condition sets as the tag (code) in the leading edge portion (header) of the digital image data is conducted.

In an image adjustment processing section 701, according to existence or not of the image processing or the processing amount determined in the image processing condition set section 105, the image processing is conducted on the original signal (Rw) of the digital image data. In a header information generation section 108, the information coding processed in the film information analysis section 103, film condition judgment section 104, or image processing condition set section 105, and the information in which the scanning condition inputted from the film scanner set input section (operation section) 102 is coding processed, are generated as one tag information. The digital image data on which the image processing is conducted, is format converted in the image data format production processing section 709, and the tag information generated in the header information generation section 108 is written. The digital image data in which the tag information is written is expressed by Rwf.

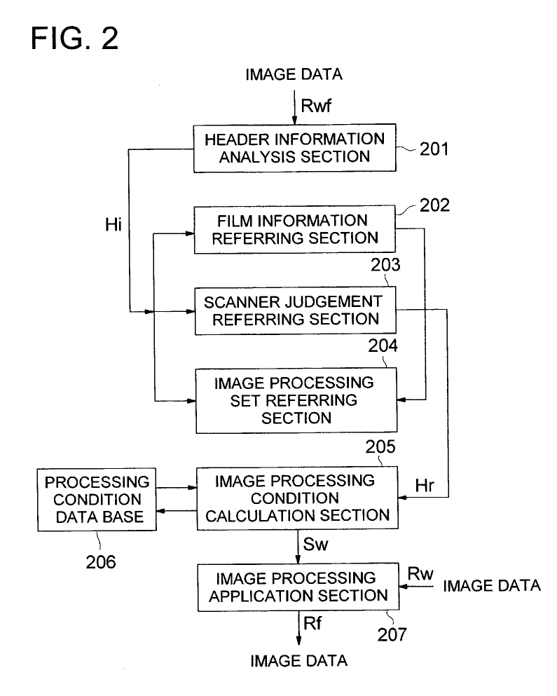

FIG. 2 is a block diagram for explaining the function of the image adjustment processing section in the image processing section 70 according to the present invention.

For the image data (Rwf), the tag information (Hi) is read in a header information analysis section 201. From the tag information (Hi), in a film information referring section 202, the code showing the kind of negative and positive film, film size, ISO sensitivity, and film product name, in a scanner judgment referring section 203, the code showing the exposure condition (under, normal, over), rear-light, gray balance, and mask density, and in an image processing set referring section 204, the code showing the existence or not of the image processing such as the γ setting, color balance set, saturation adjustment, sharpness adjustment, granularity suppression, and dust and flaw removal, or the processing amount, are-respectively read out.

The read-out tag code (Hr) is, in an image processing condition calculation section 205, used for referring a processing condition data base 206, and a final image processing condition (Sw) is determined. In an image processing application section 207, the calculated image processing condition (Sw)is applied on the image data (Rw), and the image processed image data (Rf) is obtained.

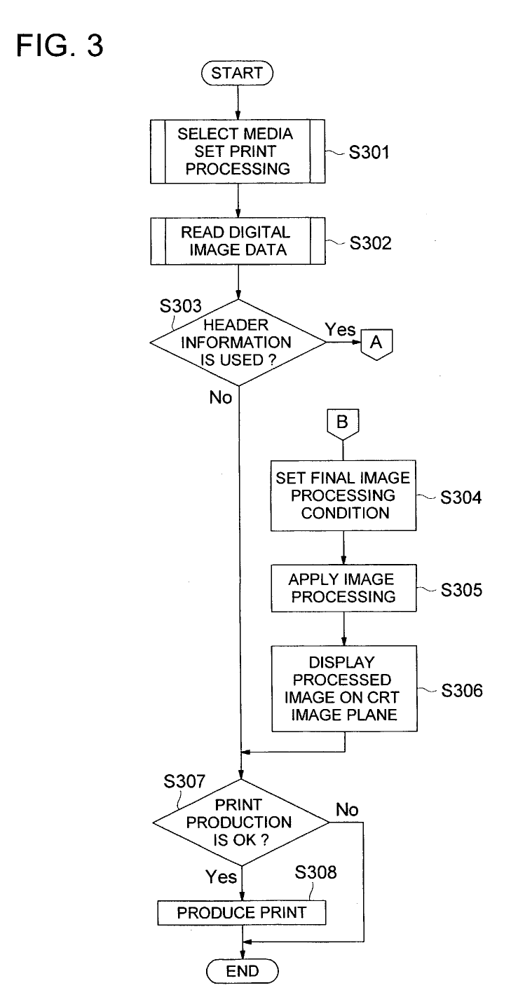

Referring to FIGS. 3-7, one embodiment of the image recording apparatus of the present invention will be further detailed below.

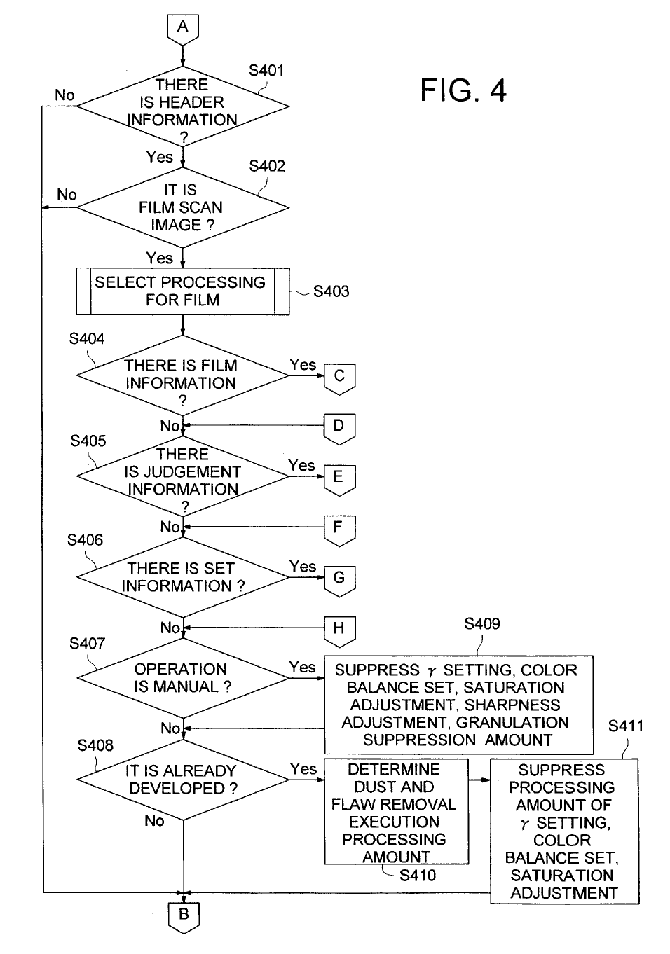

FIG. 3 is a flow chart for explaining the movement of the print processing which is one embodiment of the image recording apparatus of the present invention. After the set of the recording medium (CD-R, MO) and the print processing selection (S301), the reading of digital image data is conducted (S302). It is determined whether the header information is used (S303), and when it is used, the sequence advances to A, and a header information analysis processing flow shown in FIG. 4 is conducted, and the set of a final image processing condition (S304), application of the image processing (S305), and CRT image plane display of the processed image (S307) are conducted. When the header information is not used, the execution judgment for the print production (S307) is conducted at once, and when Yes is inputted, the print production (S308) is conducted at once.

FIG. 4 is a flowchart for explaining the movement of the header information analysis processing. It is judged whether there is the header information (S401), and when there is no header information, the processing is completed. When there is the header information, initially it is judged whether it is the film scanning image (S402) . When it is not the film scanning image, the processing is completed. When it is the film scanning image, the processing for film is selected as the initial set (S403) . Next, it is judged whether there is the film information (S404) . When there is the film information, the sequence advances to C, and the film information referring flow is conducted.

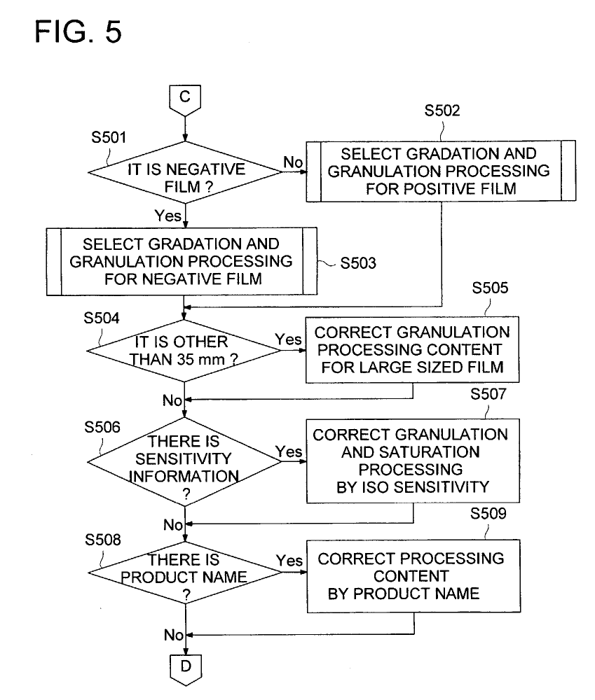

FIG. 5 is a flowchart for explaining the movement of the film information referring. It is judged whether the film is the negative film (S501), and when the film is the negative film, the gradation and granularity processing for the negative film is selected (S503). When it is the positive film, the gradation and granularity processing for the positive film is selected (S502). Successively, it is judged whether the film size is other than 35 mm (S504). When it is other than 35 mm, it is corrected to the granularity processing content for the large sized film (S505). Next, it is judged whether there is the sensitivity information (S506). When there is the sensitivity information, it is corrected to the granularity and saturation processing content by the ISO sensitivity (S507). Successively, it is judged whether there is the product name information (S508). When there is the product name information, it is corrected to the processing content by the product name (S509). When there is no product name information, the sequence advances to D.

In this film information referring flow, the relationship between the gradation and granularity processing for the negative film and the gradation and granularity processing for the positive film, is as follows.

(1) The granularity suppression degree of the granularity suppression set of the image from the negative film is higher than that of the granularity suppression set of the image from the positive film.

(2) The non-linearity degree of the gradation correction set of the image from the negative film is higher than that of the gradation correction set of the image from the positive film.

Further, the relationship between the granularity processing for the film size 35 mm, and the granularity processing for the large sized film is as follows.

(3) The granularity suppression degree of the granularity suppression set of the image from the film whose size is small, is higher than the granularity suppression degree of the granularity suppression set of the image from the film whose size is large.

Further, the granularity and saturation processing content for the low ISO sensitivity and for the high ISO sensitivity is as follows.

(4) The granularity suppression degree of the granularity suppression set of the image from the film whose ISO sensitivity is high is higher than that of the granularity suppression set of the image from the film whose ISO sensitivity is low.

(5) The emphasis degree of the saturation emphasis set of the image from the film whose ISO sensitivity is high is higher than that of the saturation emphasis set of the image from the film whose ISO sensitivity is low.

Further, the processing content for each product name is as follows.

(6) According to the film product name, at least one of the gradation conversion, sharpness emphasis, granularity suppression, color balance set, and saturation adjustment.

It will return again to the flowchart showing the movement of the header information analysis processing in FIG. 4. When it is judged that there is no film information in S404, it is judged whether there is the scanner judgment information (S405). When there is the scanner judgment information, the sequence advances to E, and the scanner judgment referring flow is conducted.

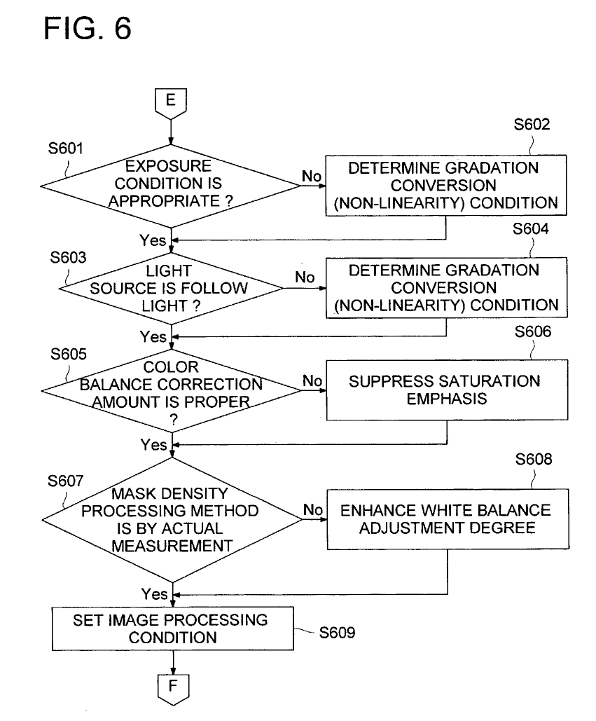

FIG. 6 is a flowchart for explaining the movement of the scanner judgment referring. Initially, it is judged whether the exposure condition is adequate (S601). When it is under or over, the gradation conversion (non-linearity) processing condition is determined for them (S602). Successively, it is judged whether the light source is a follow light (S603). When it is a rear-light, the gradation conversion (non-linearity) processing condition for the rear-light is determined (S604). In the gradation conversion (non-linearity) processing condition for the rear-light, the compression operation of the gradation range such as the dodging is also included.

Successively, it is judged whether the color balance correction amount is adequate (S605). When it is not adequate, that is, it exceeds a predetermined correction amount, it is judged that it is the artificial light source whose color temperature is very high, or low, and the saturation emphasis amount is suppressed (S606). Successively, it is judged whether the mask density processing method is by the actual measurement (S607). When it is not by the actual measurement (assumption method), it is judged that the possibility that an error is in the color balance, is high, and the degree of the white balance adjustment is enhanced (S608).

The setting of the image processing condition referred to the above-described scanner judgment information is completed (S609), and again, the sequence advances to F (FIG. 4). Next, it is judged whether there is the image processing set information (S406). When there is the image processing set information, the sequence advances to G.

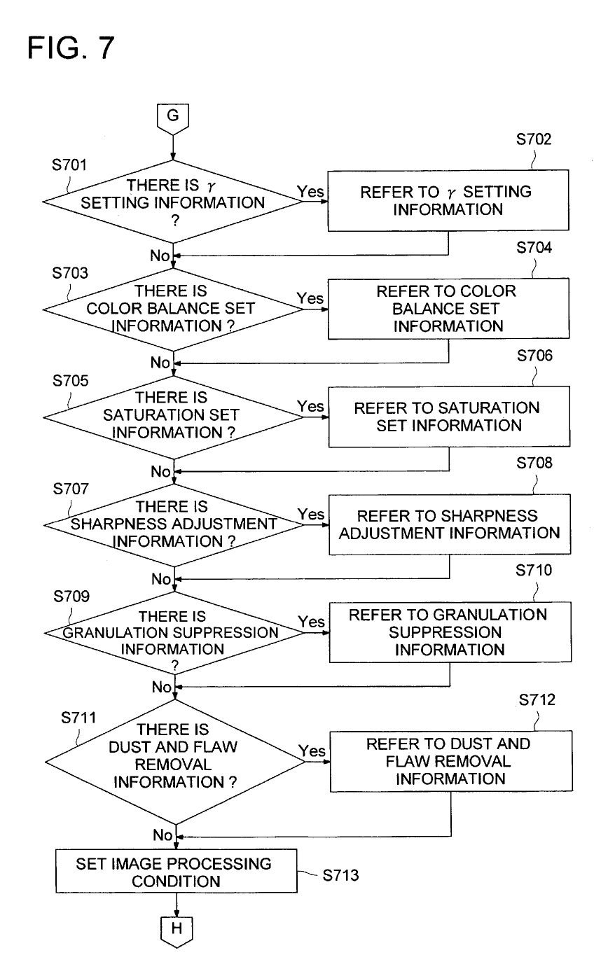

FIG. 7 is a flowchart for explaining the movement of the image processing set information referring. Initially, when there is the γ setting information, the sequence refers to the γ setting information (S702). Next, it is judged whether there is the color balance set information (S703). When there is the color balance set information, it refers to the color balance set information (S704). Successively, it is judged whether there is the saturation set information (S705). When there is the saturation set information, it refers to the saturation set information (S706).

Successively, it is judged whether there is the sharpness adjustment information (S707). When there is the sharpness adjustment information, it refers to the sharpness adjustment information (S708). Successively, it is judged whether there is the granularity suppression information (S709). When there is the granularity suppression information, it refers to the granularity suppression information (S710). Next, it is judged whether there is the dust and flaw removal information (S711). When there is the dust and flaw removal information, it refers to the dust and flaw removal information (S712).

The setting of the image processing condition referred to the above-described image processing set information is completed (S713), and the sequence advances to H. It is judged whether the operation is manual (S407). When the operation is manual, it is judged that the optimization degree of the image processing is high, or that the taste of the user is reflected, and the γ setting, color balance set, saturation adjustment, sharpness adjustment, and granularity suppression amount suppression are conducted (S409).

Finally, it is judged whether the film is already developed (S408). When the film is already developed, it is judged that the adhered amount of the dust and flaw is many, and it is determined to conduct the dust and flaw removal processing or to enhance the processing amount (S410). Further, in order to reduce the influence of the dust and flaw, the processing amount of the γ setting, color balance set, and saturation adjustment is suppressed (S411).

It is attained together to record whether it is the image information obtained from the negative film as the tag information in the image information obtained by scanning the negative film, the information relating to the film, the information used for the judgment, the information relating to the image processing set, the scanning condition set (automatic, or manual), or whether it is already developed film, and to increase the print quality and to improve the print production efficiency, by optimizing the image processing condition using the tag information.

What is claimed is:

1. An image forming method, comprising:
a scanning step of scanning a pigment image on a film and producing digital image data corresponding to the pigment image;
an additional data providing step of providing the digital image data with additional data representing at least one of a judgment result obtained by judging a photographing condition of the pigment image, an image processing condition for the digital image data determined on a basis of the judgment result for the photographing condition, a scanning condition at the scanning step; and a pigment image forming condition of the pigment image on the film;
a processing step of processing the digital image data on a basis of the additional data; and
an image forming step of forming an image on a basis of the processed digital image data.

2. The image forming method of claim 1, wherein the digital image data are raw data which have not been applied with any image processing.

3. The image forming method of claim 1, wherein the judgment result is obtained by judging at least one of a exposure condition of the pigment image, a reverse exposure, a gray balance condition, and a mask image density.

4. The image forming method of claim 1, wherein the image processing condition is at least one of a γ-setting, a color balance setting, a saturation adjustment, a sharpness adjustment, a granularity suppression, and a dust scratch elimination.

5. The image forming method of claim 1, wherein the scanning condition is an automatic scanning mode or a manual scanning mode.

6. The image forming method of claim 1, wherein the pigment image forming condition indicates that when the film is scanned, the film is a film obtained immediately after a developing process or a film carried by a customer as a developed film.

7. The image forming method of claim 1, wherein the additional data include data representing film information of the film and data indicating that the digital image data are obtained by scanning the pigment image on the film.

8. The image forming method of claim 7, wherein the film information is at least one of a kind of negative or positive film, a film size, ISO sensitivity, and a film brand name.

9. The image forming method of claim 8, wherein at the processing step, a granularity suppression for an image on a negative film is set higher than that for an image on a positive film.

10. The image forming method of claim 8, wherein at the processing step, a gradation correction for an image on a negative film is set higher in non linearity than that for an image on a positive film.

11. The image forming method of claim 8, wherein at the processing step, a granularity suppression for an image on a film having a small film size is set higher than that for an image on a film having a large film size.

12. The image forming method of claim 8, wherein at the processing step, a granularity suppression for an image on a film having a high ISO sensitivity is set higher than that for an image on a film having a low ISO sensitivity.

13. The image forming method of claim 8, wherein at the processing step, a saturation enhancement for an image on a film having a high ISO sensitivity is set higher than that for an image on a film having a low ISO sensitivity.

14. The image forming method of claim 8, wherein the processing step changes at least one of a gradation conversion, a sharpness enhancement, a granularity suppression, a color balance setting, and a saturation adjustment on the basis of a film brand name.

15. The image forming method of claim 3, wherein the additional data represents the judgment result obtained by judging the photographing condition of the pigment image and includes data indicating that the digital image data are obtained by scanning the pigment image on the film.

16. The image forming method of claim 15, wherein the processing step conducts at least one of a gradation conversion, a sharpness enhancement, a granularity suppression, a color balance setting, a saturation adjustment and a white balance adjustment.

17. The image forming method of claim 16, wherein the processing step changes a non linearity in the gradation correction depend on the exposure condition of under, normal or over exposure.

18. The image forming method of claim 16, wherein when the judgment result indicates the reverse exposure, the processing step make a non linearity in the gradation correction to be higher.

19. The image forming method of claim 16, wherein when the judgment result indicates that a value of a color balance is out of a predetermined range, the processing step suppresses the saturation enhancement.

20. The image forming method of claim 16, wherein when the judgment result indicates that a whit balance adjustment in the case that a mask image density processing method is based on an estimate value is made higher than that in the case that the mask image density processing method is based on an actual measurement value.

21. The image forming method of claim 4, wherein the additional data represents the image processing condition for the digital image data and includes data indicating that the digital image data are obtained by scanning the pigment image on the film.

22. The image forming method of claim 21, wherein the processing step changes a γ-setting with reference to the γ-setting in the image processing condition in the additional data.

23. The image forming method of claim 21, wherein the processing step changes a color balance setting with reference to the color balance setting in the image processing condition in the additional data.

24. The image forming method of claim 21, wherein the processing step changes a saturation adjustment with reference to the saturation adjustment in the image processing condition in the additional data.

25. The image forming method of claim 21, wherein the processing step changes a sharpness adjustment with reference to the sharpness adjustment in the image processing condition in the additional data.

26. The image forming method of claim 21, wherein the processing step changes a granularity suppression with reference to the granularity suppression in the image processing condition in the additional data.

27. The image forming method of claim 21, wherein the processing step changes a dust scratch elimination setting with reference to the dust scratch elimination setting in the image processing condition in the additional data.

28. The image forming method of claim 5, wherein the additional data represents the scanning condition and includes data indicating that the digital image data are obtained by scanning the pigment image on the film.

29. The image forming method of claim 28, wherein when the scanning condition is the manual scanning mode, the processing step suppresses a process of at least one of a γ-setting, a color balance setting, a saturation adjustment, a sharpness adjustment and a granularity suppression.

30. The image forming method of claim 6, wherein the additional data represents the pigment image forming condition and includes data indicating that the digital image data are obtained by scanning the pigment image on the film.

31. The image forming method of claim 30, wherein when the film is a film carried by a customer as a developed film, the processing step intensifies the dust scratch elimination.

32. The image forming method of claim 30, wherein when the film is a film carried by a customer as a developed film, the processing step suppresses a process of at least one of a γ-setting, a color balance setting and a saturation adjustment.

33. The image forming method of claim 1, wherein the image forming step forms the image with a silver halide method.

34. The image forming method of claim 1, wherein the image forming step forms the image with an ink jet method.

35. The image forming method of claim 1, wherein the image forming step forms the image with an electro-photography.

36. The image forming method of claim 1, wherein the image forming step forms the image with a sublimating method.

37. The image forming method of claim 1, wherein the image forming step forms the image with a thermal method.

38. The image forming method of claim 1, wherein the processing step stores the processed digital image data in a memory medium and outputs the processed digital image data with the memory medium.

39. The image forming method of claim 38, wherein the memory medium is one of CD-R, CD-RW, MD, a memory card, IC card, a floppy (R) disk, and a magnetic disk.

40. An image forming apparatus, comprising:
a scanning device to scan a pigment image on a film and to produce digital image data corresponding to the pigment image;
an additional data providing device to prove the digital image data with additional data representing at least one of a judgment result obtained by judging a photographing condition of the pigment image, an image processing condition for the digital image data determined on a basis of the judgment result for the photographing condition, a scanning condition at the scanning step; and a pigment image forming condition of the pigment image on the film;
a processing device to process the digital image data on a basis of the additional data; and
an image forming device to form an image on a basis of the processed digital image data.

41. The apparatus of claim 40, wherein the processing device sets a granularity suppression for an image on a negative film to be higher than that for an image on a positive film.

42. The apparatus of claim 40, wherein the processing device sets a gradation correction for an image on a negative film to be higher in non linearity than that for an image on a positive film.

43. The apparatus of claim 40, wherein the processing device sets a granularity suppression for an image on a film having a small film size to be higher than that for an image on a film having a large film size.

44. The apparatus of claim 40, wherein the processing device sets a granularity suppression for an image on a film having a high ISO sensitivity to be higher than that for an image on a film having a low ISO sensitivity.

45. The apparatus of claim 40, wherein the processing device sets a saturation enhancement for an image on a film having a high ISO sensitivity to be higher than that for an image on a film having a low ISO sensitivity.

46. The apparatus of claim 40, wherein the processing device changes at least one of a gradation conversion, a sharpness enhancement, a granularity suppression, a color balance setting, and a saturation adjustment on the basis of a film brand name.
